(19) United States
(12) Patent Application Publication
(10) Pub. No.: US 2017/0205228 A1
(43) Pub. Date: Jul. 20, 2017

(54) AREA MEASUREMENT DEVICE AND METHOD

(71) Applicant: ZTE CORPORATION, Shenzhen City (CN)

(72) Inventor: Yibo LI, Shenzhen City (CN)

(73) Assignee: ZTE CORPORATION, Shenzhen City (CN)

(21) Appl. No.: 15/318,475

(22) PCT Filed: Aug. 22, 2014
(86) PCT No.: PCT/CN2014/085072

§ 371 Date: Apr. 2, 2017

(30) Foreign Application Priority Data
Jun. 13, 2014 (CN) 201410265798.2

(51) Int. Cl. G01B 11/28; G06T 7/62; G01B 11/02

(52) U.S. Cl. CPC G01B 11/28; G01B 11/026; G06T 7/62; G06T 2207/10004

(57) ABSTRACT

An area measurement device includes an image acquisition module acquires a first image including an image of a target to be measured. A polygon establishment module determines at least one first polygon in first image formed by connecting lines between multiple first target points on the image of the target. A target point determination module determines multiple second target points on the target according to multiple first target points. A measurement module acquires a distance from a laser source to each second target point and an included angle of connecting lines between every two adjacent second target points and laser source in a laser ranging manner. A length calculation module calculates each side length of a second polygon/polygons which is/are a mapping/mappings of first polygon/polygons on the target. An area calculation module calculates an area of second polygon/polygons as an area of the target.

### CROSS-REFERENCE TO RELATED APPLICATION

This application is the U.S. national phase of PCT Application No. PCT/CN2014/085072filed Aug. 22, 2014, which claims priority to Chinese Application No. 201410265798.2 filed Jun. 13, 2014, the disclosures of which are incorporated in their entirety by reference herein.

### TECHNICAL FIELD

The present disclosure relates to the field of surveying and mapping, and more particularly to an area measurement device and method.

### BACKGROUND

Along with development of sciences and technologies, the speed of people acquiring information is continuously increased, so more advanced and quicker sciences and technologies are required to serve people. Our terminals will become the most obedient terminal products with the more advanced and quicker sciences and technologies. A conventional area calculation method is implemented by measurement and manual calculation, and the conventional area calculation method has become inadaptable to current requirements for the human development. Therefore, people need a quicker method for calculating an area of a target.

### SUMMARY

In view of this, the present disclosure provides an area measurement device and method to solve the problems of time consuming and labor consuming of area measurement, and particularly incapability of measuring an unreachable distant target in a related art.

In order to solve the abovementioned problems, the present disclosure provides an area measurement device, which includes:

an image acquisition module, arranged to acquire a first image including an image of a target to be measured;

a polygon establishment module, arranged to determine at least one first polygon in the first image, herein the first polygon/polygons is/are formed by connecting lines between a plurality of first target points on the image of the target to be measured;

a target point determination module, arranged to determine a plurality of second target points on the target to be measured according to the plurality of first target points, herein the first target points are images of the second target points in the first image;

a measurement module, arranged to acquire a distance from a laser source to each second target point and an included angle of connecting lines between every two adjacent second target points and the laser source in a laser ranging manner;

a length calculation module, arranged to calculate a side length of each side of a second polygon/polygons according to the distance from the laser source to each second target point and the included angle of the connecting lines between every two adjacent second target points and the laser source, herein the second polygon/polygons is/are a mapping/mappings of the first polygon/polygons on the target to be measured; and

an area calculation module, arranged to calculate an area of the second polygon/polygons as an area of the target to be measured according to the side length of each side of the second polygon/polygons.

Alternatively, the polygon establishment module includes:

a presentation unit, arranged to present the first image on a display screen;

an acquisition unit, arranged to acquire the plurality of first target points selected by a user based on the image of the target to be measured in the first image; and

a polygon forming unit, arranged to form the at least one first polygon based on the plurality of first target points.

Alternatively, the polygon forming unit may include:

a division unit, arranged to connect every three adjacent first target points to divide the image of the target to be measured into a plurality of triangles; and

a determination unit, arranged to determine that each triangle is the first polygon.

Alternatively, the area calculation module includes:

a first calculation unit, arranged to calculate an area of each triangle represented by the second polygon/polygons respectively;

a second calculation unit, arranged to calculate a sum value of the areas of all the triangles; and

an output unit, arranged to output the sum value as the area of the target to be measured.

Alternatively, the device further includes:

an application module, arranged to determine an application parameter of the area of the target to be measured according to an application scenario of the target to be measured.

The present disclosure further provides an area measurement method, which includes:

an image acquisition step in which a first image including an image of a target to be measured is acquired;

a polygon establishment step in which at least one first polygon is determined in the first image, herein the first polygon/polygons is/are formed by connecting lines between a plurality of first target points on the image of the target to be measured;

a target point determination step in which a plurality of second target points on the target to be measured are determined according to the plurality of first target points, herein the first target points are images of the second target points in the first image;

a measurement step in which a distance from a laser source to each second target point and an included angle of connecting lines between every two adjacent second target points and the laser source are acquired in a laser ranging manner;

a length calculation step in which a side length of each side of a second polygon/polygons is calculated according to the distance from the laser source to each second target point and the included angle of the connecting lines between every two adjacent second target points and the laser source, herein the second polygon/polygons is/are a mapping/mappings of the first polygon/polygons on the target to be measured; and

an area calculation step in which an area of the second polygon/polygons is calculated as an area of the target to be measured according to the side length of each side of the second polygon/polygons.

Alternatively, the polygon establishment step includes:

a presentation step in which the first image is presented on a display screen;

an acquisition step in which the plurality of first target points selected by a user based on the image of the target to be measured in the first image are acquired; and

a polygon forming step in which the at least one first polygon is formed based on the plurality of first target points.

Alternatively, the polygon forming step includes:

a division step in which every three adjacent first target points are connected to divide the image of the target to be measured into a plurality of triangles; and

a determination step in which each triangle is determined to be the first polygon.

Alternatively, the area calculation step includes:

a first calculation step in which an area of each triangle represented by the second polygon/polygons is calculated respectively;

a second calculation in which that a sum value of the areas of all the triangles is calculated; and

an output step in which the sum value is output as the area of the target to be measured.

Alternatively, the method further includes:

an application step in which an application parameter of the area of the target to be measured is determined according to an application scenario of the target to be measured.

According to the area measurement device and method of the embodiment of the present disclosure, the distances from the laser source to the second target points on the target to be measured and the included angles of the connecting lines between every two adjacent second target points and the laser source are measured to obtain distances between different points on the target to be measured, thereby the area of the target to be measured is calculated according to the distances. In such a manner, the user may acquire the area of the target to be measured in distal, and great convenience is brought to the user, and area measurement is more convenient, quick, time-saving and labor-saving.

### BRIEF DESCRIPTION OF DRAWINGS

FIG. 1 is a structure diagram of an area measurement device according to an embodiment of the present disclosure.

FIG. 2 is a flowchart of an area measurement method according to an embodiment of the present disclosure.

FIG. 3 is another structure diagram of an area measurement device according to an embodiment of the present disclosure.

FIG. 4 is another flowchart of an area measurement method according to an embodiment of the present disclosure.

### SPECIFIC EMBODIMENTS

Detailed descriptions will be made below with reference to the drawings and specific embodiments.

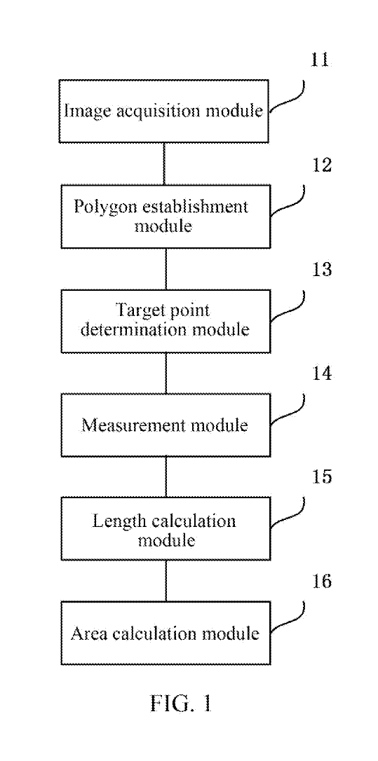

FIG. 1 is a structure diagram of an area measurement device according to an embodiment of the present disclosure. As shown in FIG. 1, the present disclosure provides an area measurement device, which includes the following modules.

An image acquisition module 11 is arranged to acquire a first image including an image of a target to be measured.

A polygon establishment module 12 is arranged to determine at least one first polygon in the first image, herein the first polygon/polygons is/are formed by a plurality of first target points on the image of the target to be measured.

A target point determination module 13 is arranged to determine a plurality of second target points on the target to be measured according to the plurality of first target points, herein the first target points are images of the second target points in the first image.

A measurement module 14 is arranged to acquire a distance from a laser source to each second target point and an included angle of connecting lines between every two adjacent second target points and the laser source in a laser ranging manner.

A length calculation module 15 is arranged to calculate a side length of each side of a second polygon/polygons according to the distance from the laser source to each second target point and the included angle of the connecting lines between every two adjacent second target points and the laser source, herein the second polygon/polygons is/are a mapping/mappings of the first polygon/polygons on the target to be measured.

An area calculation module 16 is arranged to calculate an area of the second polygon/polygons as an area of the target to be measured according to the side length of each side of the second polygon/polygons.

According to the area measurement device of the embodiment, the polygon establishment module 12 is adopted to determine the at least one first polygon formed by connecting lines between the plurality of first target points on the image of the target to be measured, thereby the target point determination module 13 finds a plurality of second target points, corresponding to the first target points, on the target to be measured, and then the length calculation module 15 and the area calculation module 16 calculate the area of the second polygon/polygons, corresponding to the first polygon/polygons, virtually formed by the plurality of second target points as the area of the target to be measured under the assistance of the measurement module 14. Therefore, the area measurement device of the embodiment abandons a conventional area measurement manner, and adopts a modern advanced technology and measurement concept to make area measurement convenient, quick, time-saving and labor-saving.

Alternatively, the polygon establishment module specifically includes the following units.

A presentation unit is arranged to present the first image on a display screen.

An acquisition unit is arranged to acquire the plurality of first target points selected by a user based on the image of the target to be measured in the first image.

A polygon forming unit is arranged to form the at least one first polygon according to the plurality of first target points.

Specifically, the first image acquired by the image acquisition module 11 is displayed by the presentation unit; and then the first target points are acquired through the acquisition unit. An acquisition process of the first target points may be determined by each vertex angle of a pre-stored geometric figure. For example, a shape such as a square, a rhombus and a trapezoid and so on is pre-stored, and the shape of a geographic figure to be selected is determined according to a specific shape of the image of the target to be measured in the first image. For example, when the target to be measured is a triangle, a pre-stored triangle may be selected to be overlapped with edges of the image of the target to be measured. Here, it is necessary to regulate and rotate the triangle on a plane according to an edge contour of the target to be measured to make the triangle completely enclose the image of the target to be measured in the triangle in a fit manner. The three vertex angles of the triangle are determined as the first target points.

If the target to be measured is an irregular geometric shape or when surfaces of the target to be measured are not on the same plane, a manual manner may also be adopted to select the multiple first target points, and then a plurality of first polygons are formed by the polygon forming unit. It should be noted that the plurality of first polygons formed here are not overlapped, and instead, they are connected with one another and cover the whole area of the image of the target to be measured. Under that condition, the number and the distribution of the first target points are determined according to a complexity of a practical contour of the target to be measured. For example, when the target to be measured is a spherical body, a plurality of first target points on images of a plurality of spherical surfaces may be acquired at first, and then a few adjacent first target points are connected to be the first polygons, and a plurality of first polygons are required to be formed at this moment. Then areas of a plurality of second polygons corresponding to the plurality of first polygons are calculated, thereby obtaining the area of the target to be measured.

During area calculation, an area of a triangle is relatively easier to be calculated. For an irregular geometric figure, it is divided into a plurality of triangles for easier implementation. Alternatively, the polygon forming unit specifically includes the following units.

A division unit is arranged to connect every three adjacent first target points to divide the image of the target to be measured into a plurality of rectangles.

A determination unit is arranged to determine that each triangle is a first polygon.

Specifically, a plurality of first target points are acquired on an image of a target to be measured which is an irregular geometric figure or of which surfaces are not on the same plane. Then every three adjacent target points are connected, thereby dividing the image of the target to be measured into a plurality of triangles with equal areas or unequal areas. The plurality of triangles are determined as the first polygons, and then areas of second polygons corresponding to the plurality of triangles are calculated to obtain an area of the target to be measured. By the technical solution of the embodiment, the calculated area of the target to be measured may meet an accuracy requirement. Considering the accuracy requirement on the area of the target to be measured, the number of the first target points may be increased, thereby achieving purposes of refined division and accurate calculation.

Alternatively, the area calculation module specifically includes the following units.

A first calculation unit is arranged to calculate an area of each triangle represented by the second polygon/polygons respectively.

A second calculation unit is arranged to calculate a sum value of the areas of all the triangles.

An output unit is arranged to output the sum value as the area of the target to be measured.

In order to improve practicability of the area measurement device of the present disclosure, the device may further include:

an application module, arranged to determine an application parameter of the area of the target to be measured according to an application scenario of the target to be measured. After the area of the target to be measured is calculated, the application scenario of the area of the target to be measured may be selected through the application module. Application parameters for each application scenario are preset. For example, for a house painting, a using amount of the painting is obtained by virtue of a preset corresponding parameter between an area and a painting using amount and a calculated area of a house wall. When the target to be measured is a television wall, a television size may be provided for a user to refer to by a preset size comparison parameter between an area of the television wall and a television. A television with the corresponding size may further be displayed at a corresponding position on a picture for the user to refer to.

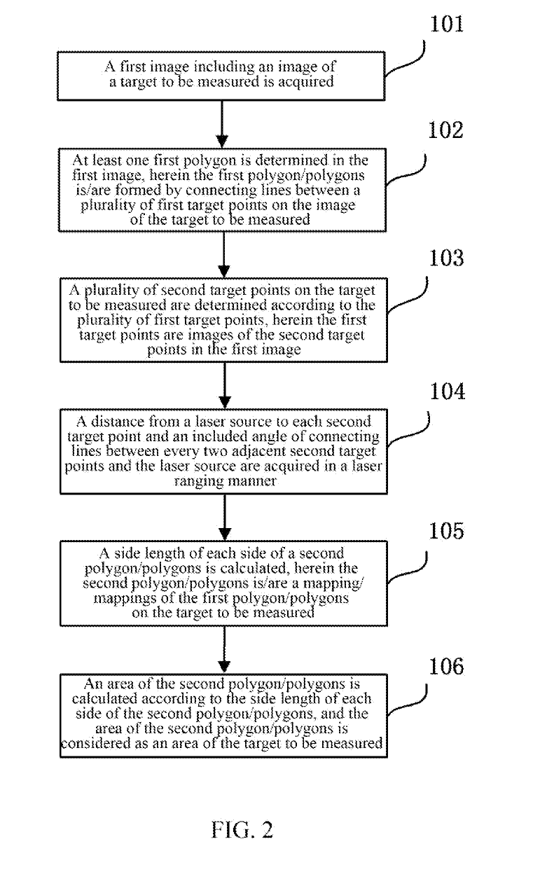

FIG. 2 is a flowchart of an area measurement method according to an embodiment of the present disclosure. As shown in FIG. 2, the present disclosure provides an area measurement method, which includes:

an image acquisition step 101, in which a first image including an image of a target to be measured is acquired;

a polygon establishment step 102, in which at least one first polygon is determined in the first image, herein the first polygon/polygons is/are formed by a plurality of first target points on the image of the target to be measured;

a target point determination step 103, in which a plurality of second target points on the target to be measured are determined according to the plurality of first target points, herein the first target points is images of the second target points in the first image;

a measurement step 104, in which a distance from a laser source to each second target point and an included angle of connecting lines between every two adjacent second target points and the laser source are acquired in a laser ranging manner;

a length calculation step 105, in which a side length of each side of a second polygon is calculated according to the distance from the laser source to each second target point and the included angle of the connecting lines between every two adjacent second target points and the laser source, herein the second polygon/polygons is/are a mapping/mappings of the first polygon/polygons on the target to be measured; and

an area calculation step 106, in which an area of the second polygon/polygons is calculated as an area of the target to be measured according to the side length of each side of the second polygon/polygons.

Alternatively, the polygon establishment step specifically includes:

a presentation step in which the first image is presented on a display screen;

an acquisition step in which the plurality of first target points, which are selected by a user according to the image of the target to be measured in the first image, are acquired; and

a polygon forming step in which the at least one first polygon is formed according to the plurality of first target points.

Alternatively, the polygon forming step specifically includes:

a division step in which every three adjacent first target points are connected to divide the image of the target to be measured into a plurality of triangles; and

a determination step in which each triangle is determined to be a first polygon.

Alternatively, the area calculation step specifically includes:

a first calculation step in which an area of each triangle represented by the second polygon/polygons is calculated respectively;

a second calculation step in which a sum value of the areas of all the triangles is calculated; and

an output step in which the sum value is output as the area of the target to be measured.

Alternatively, the method further includes:

an application step in which an application parameter of the area of the target to be measured is determined according to an application scenario of the target to be measured.

The essence of the technical solution of the abovementioned embodiment includes the following operations. The first target points on the image of the target to be measured are acquired; thereby the second target points on the target to be measured are determined. The distances from the second target points to the laser source and the included angles of different connecting lines from the second target points to the laser source are acquired in the laser ranging manner. Distances between different points on the target to be measured are calculated by virtue of the distances and the included angles. Then the area of the target to be measured is calculated by virtue of these distances. In such a manner, the user may obtain the area of the target to be measured through the distances only by operating on a distant device, which brings great convenience to the user.

The abovementioned embodiments are only the alternative embodiments of the present disclosure, and any combinations and modifications of the embodiments shall fall within the scope of protection of the present disclosure.

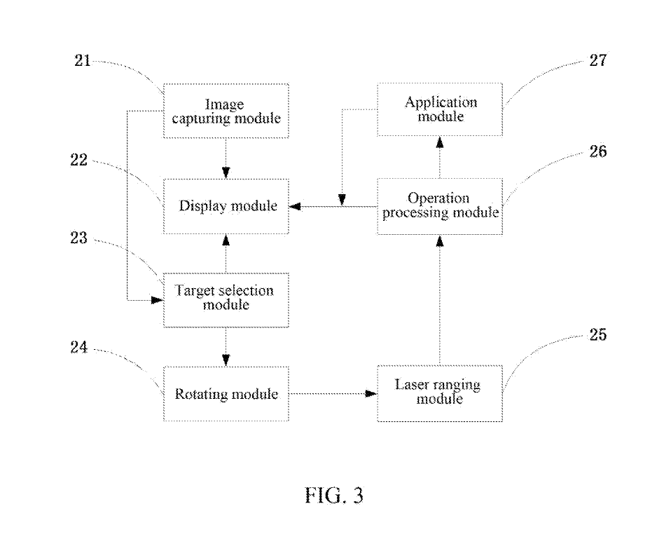

FIG. 3 is another structure diagram of an area measurement device according to an embodiment of the present disclosure. As shown in FIG. 3, the area measurement device of the embodiment of the present disclosure includes the following modules.

An image capturing module 21 is arranged to acquire a first image including an image of a target to be measured.

The target to be measured in the embodiment is a door sheet. Specifically, the image capturing module 21 is arranged to acquire the first image including an image of the door sheet.

A display module 22 is arranged to present the first image, that is, display the first image including the image of the door sheet to a user.

A target selection module 23 is arranged to select a pre-stored geometric figure consistent with a contour of the image of the target to be measured to enclose and fit the image of the target to be measured with the geometric figure according to the contour of the image of the target to be measured, and determine each vertex angle of the geometric figure as first target points. Herein, the geometric figure is a first polygon,

The target to be measured in the present embodiment is the door sheet. The user specifically selects a rectangle from geometric figures to be selected through the target selection module 23, and adjusts a size and position of the rectangle to completely enclose the image of the door sheet in the rectangle and fit a contour of the image of the door sheet with each side of the rectangle, and determines four vertex angles of the rectangle as the first target points.

A rotating module 24 is arranged to project a laser source to the plurality of second target points on the target to be measured according to the plurality of first target points, and record an included angle of connecting lines between every two adjacent second target points and the laser source. Herein, the first target points are images of the second target points in the first image.

The rotating module 24 projects the laser source to the second target points corresponding to the four vertex angles on the door sheet after acquiring positions of the first target points.

A laser ranging module 25 is arranged to acquire a distance from the laser source to each second target point in a laser ranging manner.

In the present embodiment, the top two vertex angles of the door sheet are represented by A and B respectively, and the laser source is represented by C, and distances from A and B to C are represented by x and y respectively, and an included angle between x and y is represented by α.

An operation processing module 26 is arranged to calculate a side length of each side of a second polygon according to the distance from the laser source to each second target point and the included angle of the connecting lines between every two adjacent second target points and the laser source, and according to the side length of each side of the second polygon, calculate an area of the second polygon/polygons as an area of the target to be measured. Herein, the second polygon/polygons is/are a mapping/mappings of the first polygon on the target to be measured.

In the present embodiment, a distance between A and B is represented by z, and z=x+y−2*x*y*cosα, and then the distance z between the top two vertex angles of the door sheet may be obtained. In the same way, each side length of the door sheet may be calculated. Finally, an area of the whole door sheet is obtained by virtue of a rectangle area calculation manner according to the two side lengths of long and wide sides of the door sheet.

An application module 27 is arranged to determine an application parameter of the area of the target to be measured according to an application scenario of the target to be measured.

In the present embodiment, it is assumed that the user measures the area of the door sheet to paint the whole door sheet. A corresponding conversion parameter between an area and a painting amount is pre-stored in the application module 27. When the user selects to apply the area to a painting option, the application module 27 may calculate a using amount of the painting for the whole door sheet by virtue of the area of the door sheet, and the using amount will be displayed to the user through the display module 22.

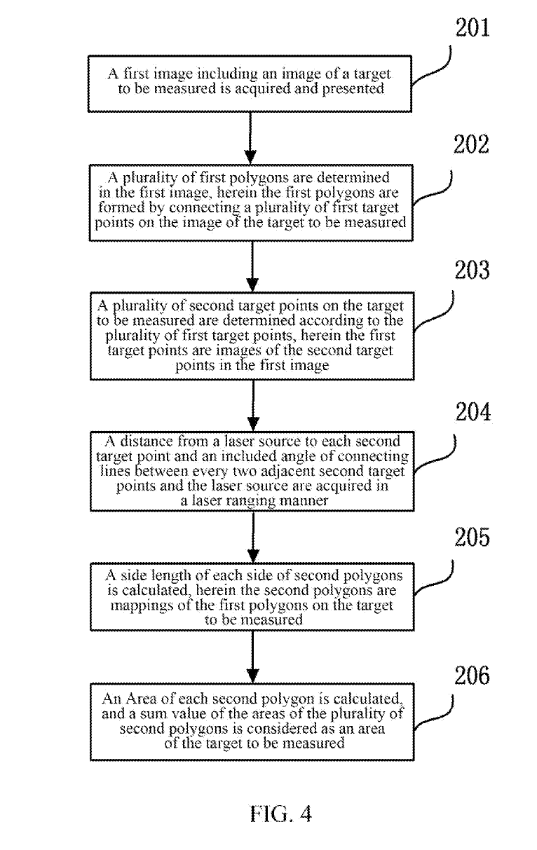

FIG. 4 is another flowchart of an area measurement method according to an embodiment of the present disclosure. The area measurement method of the embodiment of the present disclosure is applied to an area measurement device, and the device includes: an image capturing module 21, a display module 22, a target selection module 23, a rotating module 24, a laser ranging module 25, an operation processing module 26 and an application module 27. As shown in FIG. 4, the area measurement method of the embodiment includes the following steps.

In step 201, a first image including an image of a target to be measured is acquired and presented.

In the embodiment, the target to be measured is a spherical surface, and a first image including an image of the spherical surface is acquired through the image capturing module 21, and the first image including the image of the spherical surface is displayed through the display module 22.

In step 202, a plurality of first polygons are determined in the first image, herein the first polygons are formed by the plurality of first target points on the image of the target to be measured.

The image of the spherical surface is divided into a plurality of first polygons which are connected with one another through the target selection module 23. In the present embodiment, the first polygons may be triangles, and each triangle has a common side. Vertex angles of the plurality of triangles are determined as first target points.

In step 203, a plurality of second target points on the target to be measured are determined according to the plurality of first target points. Herein, the first target points are images of the second target points in the first image.

The second target points, corresponding to the plurality of first target points, on the spherical surface are determined through the rotating module 24, and a laser source is projected onto the second target points on the spherical surface respectively.

In step 204, a distance from a laser source to each second target point and an included angle of connecting lines between every two adjacent second target points and the laser source are acquired in a laser ranging manner.

By virtue of the rotating module 24, the laser ranging module 25 measures the distance from the laser source to each second target point and the included angle of the connecting lines between every two adjacent second target points and the laser source in the laser ranging manner.

In step 205, a side length of each side of second polygons is calculated according to the distance from the laser source to each second target point and the included angle of the connecting lines between every two adjacent second target points and the laser source. Herein, the second polygons are mappings of the first polygons on the target to be measured.

Since there are a plurality of first polygons, there are also a plurality of corresponding virtual second polygons on the spherical surface, and the second polygons are magnified triangles. In Step 205, the side length of each side of each second polygon is calculated through the operation processing module 26.

In step 206, an area of each second polygon is calculated according to the side length of each side of the second polygons, and a sum value of the areas of the plurality of second polygons is determined as an area of the target to be measured.

The area of each second polygon is further calculated according to the side length of each side of the second polygons through the operation processing module 26, that is, area of each triangle is calculated according to side lengths of three sides of the triangles by virtue of a triangle area formula. A sum value of the areas of the plurality of triangles is calculated to obtain a surface area of the spherical surface.

According to the technical solution of the present embodiment, the distances from the laser source to the second target points on the target to be measured and the included angles of the connecting lines between every two adjacent second target points and the laser source are measured to obtain distances between different points on the target to be measured, thereby the area of the target to be measured is calculated according to the distances. In such a manner, a user may acquire the area of the target to be measured in distal, and great convenience is brought to the user.

The above is the alternative implementation mode of the present disclosure. It should be noted that those ordinary people skilled in the art may further make a plurality of improvements and embellishments without departing from the principle of the present disclosure. The improvements and embellishments shall also fall within the scope of protection of the present disclosure.

### INDUSTRIAL APPLICABILITY

According to the area measurement device and method of the embodiment of the present disclosure, the distances from the laser source to the second target points on the target to be measured and the included angles of the connecting lines between every two adjacent second target points and the laser source are measured to obtain distances between different points on the target to be measured, thereby the area of the target to be measured is calculated according to the distances. In such a manner, a user may acquire the area of the target to be measured in distal, great convenience is brought to the user, and area measurement is more convenient, quick, time-saving and labor-saving.

What we claim is:

1. An area measurement device, comprising:
an image acquisition module, arranged to acquire a first image comprising an image of a target to be measured;
a polygon establishment module, arranged to determine at least one first polygon in the first image, wherein the first polygon/polygons is/are formed by connecting lines between a plurality of first target points on the image of the target to be measured;
a target point determination module, arranged to determine a plurality of second target points on the target to be measured according to the plurality of first target points, wherein the first target points are images of the second target points in the first image;
a measurement module, arranged to acquire a distance from a laser source to each second target point and an included angle of connecting lines between every two adjacent second target points and the laser source in a laser ranging manner;
a length calculation module, arranged to calculate a side length of each side of a second polygon/polygons according to the distance from the laser source to each second target point and the included angle of the connecting lines between every two adjacent second target points and the laser source, wherein the second polygon/polygons is/are a mapping/mappings of the first polygon/polygons on the target to be measured; and
an area calculation module, arranged to calculate an area of the second polygon/polygons as an area of the target to be measured according to the side length of each side of the second polygon/polygons.

2. The device according to claim 1, wherein the polygon establishment module comprises:
a presentation unit, arranged to present the first image on a display screen;
an acquisition unit, arranged to acquire the plurality of first target points selected by a user based on the image of the target to be measured in the first image; and
a polygon forming unit, arranged to form the at least one first polygon based on the plurality of first target points.

3. The device according to claim 2, wherein the polygon forming unit comprises:
a division unit, arranged to connect every three adjacent first target points to divide the image of the target to be measured into a plurality of triangles; and
a determination unit, arranged to determine that each triangle is the first polygon.

4. The device according to claim 3, wherein the area calculation module comprises:
a first calculation unit, arranged to calculate an area of each triangle represented by the second polygon/polygons respectively;
a second calculation unit, arranged to calculate a sum value of the areas of all the triangles; and
an output unit, arranged to output the sum value as the area of the target to be measured.

5. The device according to claim 1, further comprising:
an application module, arranged to determine an application parameter of the area of the target to be measured according to an application scenario of the target to be measured.

6. An area measurement method, comprising:
an image acquisition step, which comprises acquiring a first image comprising an image of a target to be measured;
a polygon establishment step, which comprises determining at least one first polygon in the first image, wherein the first polygon/polygons is/are formed by connecting lines between a plurality of first target points on the image of the target to be measured;
a target point determination step, which comprises determining a plurality of second target points on the target to be measured according to the plurality of first target points, wherein the first target points are images of the second target points in the first image;
a measurement step, which comprises acquiring a distance from a laser source to each second target point and an included angle of connecting lines between every two adjacent second target points and the laser source in a laser ranging manner;
a length calculation step, which comprises calculating a side length of each side of a second polygon/polygons according to the distance from the laser source to each second target point and the included angle of the connecting lines between every two adjacent second target points and the laser source, wherein the second polygon/polygons is/are a mapping/mappings of the first polygon/polygons on the target to be measured; and
an area calculation step, which comprises calculating an area of the second polygon/polygons as an area of the target to be measured according to the side length of each side of the second polygon/polygons.

7. The method according to claim 6, wherein the polygon establishment step comprises:
a presentation step, which comprises presenting the first image on a display screen;
an acquisition step, which comprises acquiring the plurality of first target points selected by a user based on the image of the target to be measured in the first image; and
a polygon forming step, which comprises forming the at least one first polygon based on the plurality of first target points.

8. The method according to claim 7, wherein the polygon forming step comprises:
a division step, which comprises connecting every three adjacent first target points to divide the image of the target to be measured into a plurality of triangles; and
a determination step, which comprises determining that each triangle is the first polygon.

9. The method according to claim 8, wherein the area calculation step comprises:
a first calculation step, which comprises calculating an area of each triangle represented by the second polygon/polygons respectively;
a second calculation step, which comprises calculating a sum value of the areas of all the triangles; and
an output step, which comprises outputting the sum value as the area of the target to be measured.

10. The method according to claim 6, further comprising:
an application step, which comprises determining an application parameter of the area of the target to be measured according to an application scenario of the target to be measured.
